(19) United States
(12) Patent Application Publication
(10) Pub. No.: US 2006/0048751 A1
(43) Pub. Date: Mar. 9, 2006

(54) Pressure booster with stroke-dependent damping

(76) Inventors: Christian Grimmiger, Leonberg (DE); Andreas Kellner, Tamm (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 10/532,505

(22) PCT Filed: Jul. 7, 2003
(86) PCT No.: PCT/DE03/02312

§ 371 Date: Apr. 25, 2005

(30) Foreign Application Priority Data
Nov. 7, 2002 (DE) 102 51 679.0

(51) Int. Cl. F02M 57/02

(52) U.S. Cl. 123/446; 123/467; 239/88; 123/496

(57) ABSTRACT

A pressure booster for a fuel injection device, with a piston-shaped pressure boosting element accommodated in a housing and dividing a working chamber from a differential pressure chamber. A control line connects the differential pressure chamber to a high-pressure source or pressure-relieves it into a low-pressure region. A return spring acts on the piston-shaped pressure boosting element and rests against an annular insert inside the housing. The insert has a damper throttle via which fuel flows from the working chamber of the pressure booster into a hydraulic chamber when the pressure in the differential pressure chamber is relieved.

### TECHNICAL FIELD

Both pressure-controlled and stroke-controlled injection systems can be used to supply fuel to combustion chambers of autoignition internal combustion engines. In addition to unit injectors and unit pumps, accumulator injection systems are also used as fuel injection systems. Accumulator (common rail) injection systems advantageously make it possible to adapt the injection pressure to the load and speed of the internal combustion engine. In general, producing high specific outputs and reducing emissions of the internal combustion engine require the highest possible injection pressure.

### PRIOR ART

For strength reasons, the achievable pressure level in accumulator injection systems currently in use is limited to approximately 1600 to 1800 bar. To further increase the pressure in accumulator injection systems, pressure boosters are used in them.

EP 0 562 046 B1 has disclosed an actuation and valve system with damping for an electronically controlled injection unit. This actuation and valve system for a hydraulic unit has an electrically excitable electromagnet with a fixed stator and a movable armature. The armature has a first surface and a second surface. The first and a second surface of the armature delimit a first and second chamber, the first surface of the armature being oriented toward the stator. A valve is provided, which is connected to the armature. The valve is positioned so that it can convey a hydraulic actuation fluid from a sump to the injection device. A damping fluid can be accumulated in and drained from one of the chambers of the electromagnet system. A region of a valve that protrudes into a central bore can be used to selectively open or close the flow connection of the damping fluid in proportion to its viscosity.

DE 199 10 970 A1 and DE 102 18 635.9 have disclosed fuel injection devices that each contain a pressure boosting unit. The pressure boosting unit has a working chamber and has a differential pressure chamber that can be pressure-relieved in order to actuate the pressure boosting unit. A piston-shaped boosting element separates the differential pressure chamber and the working chamber of the pressure boosting unit from each other.

The pressure boosting units known from DE 199 10 970 A1 and DE 102 18 635.9 are actuated through the relief of pressure in the differential pressure chamber or through the exertion of pressure on it, which is more favorable in terms of the attendant pressure-relief losses. An abrupt exertion of pressure on the high-pressure chamber of the pressure boosting unit, which occurs when the pressure in the differential pressure chamber of the pressure boosting unit is relieved, leads to an immediate buildup of the maximum pressure in accordance with the dimensioning of the piston-shaped booster element of the pressure boosting unit. As a result, the pressure boosting unit abruptly generates the maximum pressure in the high-pressure chamber, which can be undesirable when trying to achieve the injection of extremely small quantities into the combustion chamber of an autoignition internal combustion engine, for example in the context of a preinjection. Shaping an injection pressure curve so as to achieve the injection of extremely small quantities of fuel into the combustion chamber of the autoignition internal combustion engine for pilot injection or preinjection phases can only be achieved with difficulty by means of the pressure boosting units known from DE 199 10 970 A1 and DE 102 18 635.9.

### DEPICTION OF THE INVENTION

With the design of a pressure booster proposed according to the present invention, a component that is already contained in the pressure booster and serves to support the return spring can be used for stroke damping because it has a throttle restriction integrated into it. By providing a close fit between the return spring stop, which is affixed to the housing and can now be used as a damping element, and the piston-shaped pressure boosting element of the pressure booster, which element can move in relation to this return spring stop, makes it possible to assure that when the pressure booster is actuated, a full compensation for the volume increase from the working chamber of the pressure booster into a damping chamber occurs to a limited degree by means of the throttle restriction.

In addition, the piston-shaped pressure boosting element of the pressure booster can be provided with a hydraulic surface that is embodied, for example, in the shape of a truncated cone. Part of the surface is encompassed by an annular region of the return spring stop that is now used as a damping element, which annular region encompasses the piston-shaped pressure boosting element. As a result, the entire surface of the pressure boosting element, which delimits the damping chamber underneath the damping element, is not subjected to the pressure prevailing in the working chamber of the pressure booster.

An end surface of the piston-shaped pressure boosting element of the pressure booster does in fact travel into the high-pressure chamber of the pressure booster when the pressure in the differential pressure chamber is relieved, but when a lower pressure is exerted on the high-pressure chamber, an outflow of highly pressurized fuel from the high-pressure chamber occurs on a smaller scale because of the hydraulic throttle cross sections connected to the downstream side of this high-pressure chamber, e.g. bores, the seat at the combustion chamber end of the injection valve element, and the injection orifices. As a result, the inward travel that causes the pressure increase in the high-pressure chamber of the pressure booster occurs at a significantly lower speed.

However, depending on the stroke distance of the piston-shaped pressure boosting element, a control edge provided on it in the region of the damping element can advantageously result in the fact that as soon as it opens, the working pressure prevailing in the working chamber of the pressure booster also prevails in the damper chamber underneath the damping element, which can be embodied as annular, against the entire hydraulic surface of the piston-shaped pressure boosting element oriented toward the damping chamber. As a result, the maximum pressure in the high-pressure chamber of the pressure booster only occurs with fuel quantities that are greater than the fuel quantities required for a low number of preinjections to be carried out. This offers the advantage that on the one hand, preinjections with a small injection quantity and low injection pressure can be produced, but the full pressure increase that can be achieved in accordance with the dimensions of the pressure booster can be used to an unlimited degree for main injection phases.

### DRAWINGS

The present invention will be explained in greater detail below in conjunction with the drawings.

FIG. 1 shows a section through the pressure booster proposed according to the present invention, with an integrated damping element that functions in a stroke-dependent manner and

FIG. 2 shows an embodiment variant of a damping element that functions in a stroke-dependent manner.

### EMBODIMENT VARIANTS

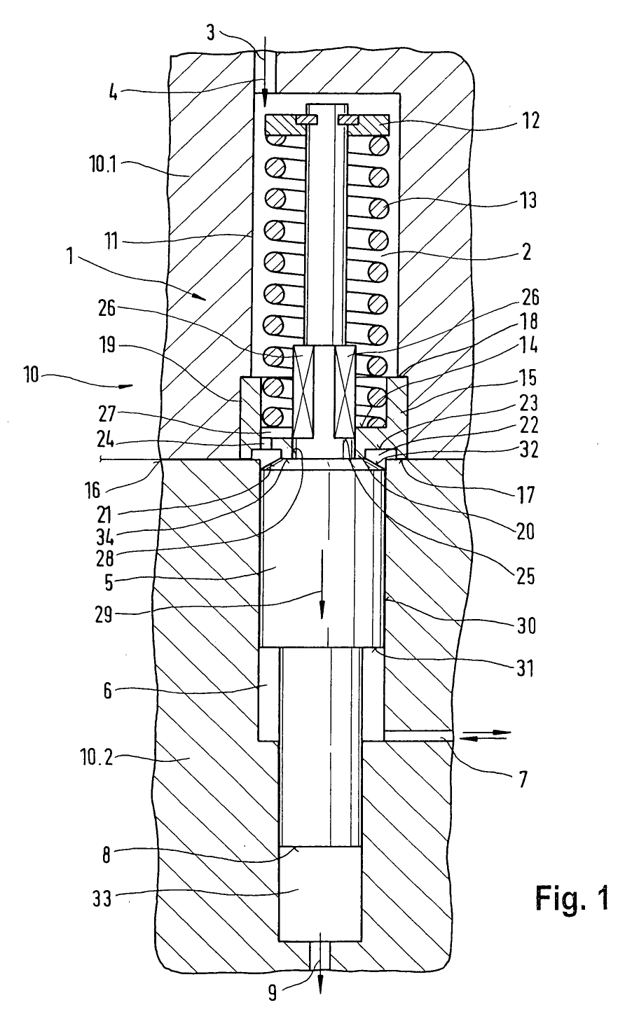

The pressure booster 1 depicted in FIG. 1 has a working chamber 2. A high-pressure line 3 acts on the working chamber 2 of the pressure booster 1 with highly pressurized fuel. The fuel source that supplies the highly pressurized fuel to the high-pressure line 3 is not depicted in detail in the drawing. It can, for example, be a high-pressure supply unit or a high-pressure accumulator (common rail). The pressure booster 1 depicted in the sectional view in the drawings can be integrated into the injector body of a fuel injector and is preferably disposed above the fuel injector. The reference numeral 4 indicates the inflow direction of the highly pressurized fuel into the working chamber 2 of the pressure booster 1.

The pressure booster 1 has a piston-shaped pressure boosting element 5. The pressure boosting element 5 divides the working chamber 2 of the pressure booster 1 from a differential pressure chamber 6. The differential pressure chamber 6 can be depressurized or pressurized by means of a control line 7. A displacement of fuel volumes from the pressure chamber 6 occurs through the actuation of an on/off valve, not shown in the drawing, for example a solenoid valve, a piezoelectric actuator, or the like. The arrow pointing away from the control line 7 symbolizes the flow direction of the fuel flowing out from the differential pressure chamber 6 and the arrow pointing toward the control line 7 indicates the inflow direction of fuel into the differential pressure chamber 6 during the return phase of the pressure boosting element 5 of the pressure booster 1.

The piston-shaped pressure boosting element 5 of the pressure booster 1 has a lower end surface 8 that travels into a high-pressure chamber of the pressure booster 1, which chamber is labeled with the reference numeral 33. When the piston-shaped pressure boosting element 5 travels inward, it displaces a highly pressurized fuel volume out of the high-pressure chamber 33 and into a discharge line 9. The discharge line 9 can, for example, extend to a nozzle chamber encompassing an injection valve element that belongs to a fuel injector and is embodied in the form of a nozzle needle. Depending on the position of the injection valve element, which as a rule moves in the vertical direction, its seat at the end oriented toward the combustion chamber is opened or closed, thus allowing or preventing an injection of highly pressurized fuel into the combustion chamber of the autoignition internal combustion engine.

The housing 10 containing the pressure booster 1 can include a first housing part 10.1, which essentially encompasses the working chamber 2, and another housing part 10.2. The two housing parts 10.1 and 10.2 of the housing 10 rest against each other along a housing division 16.

The wall of the working chamber 2 is labeled with the reference numeral 11 and is comprised of the material of the first housing part 10.1 of the housing 10. The piston-shaped pressure boosting element 5 has a support disk 12 in the upper region of the working chamber 2. The support disk 12 supports a return spring element 13, whose end oriented away from the support disk 12 rests against a disk-shaped damping element 15. The damping element has a support surface 14 against which the return spring 13 rests. Along a support surface 17, the damping element 15 rests against the second housing part 10.2 of the housing 10. The damping element is contained in a stationary fashion inside the first housing part 10.1 and during assembly of the multipart housing 10, is inserted into the first housing part 10.1, in a recess above the dividing seam of the housing division 16.

The damping element 15 has an outer ring 19 and an inner ring 20. At the lower end of the outer ring 19 of the damping element 15, there is an annular surface that rests against the second housing part 10.2 at the above-mentioned support surface 17 of the damping element 15. The damping element 15 also has a delimiting surface 23, which delimits a damping chamber 22. The damping chamber 22 can also be delimited by a surface region 21 of the pressure boosting element 5, which surface region is embodied in the shape of a truncated cone, for example, or can also be flat. The truncated cone-shaped region 21, which constitutes a hydraulically effective surface 32, only becomes effective once fuel overflows from the working chamber 2 into the damping chamber 22. A damper throttle 24 is provided, which passes through the damping element 15, i.e. perforating its support surface 14. In the position of the pressure boosting element 5 according to the drawing, the inner ring 20 of the damping element 15 covers over an annular region 34 of the pressure boosting element 5; this annular region 34 adjoins the truncated cone-shaped circumferential surface region 21 and functions hydraulically in the same way as the truncated cone-shaped region 21. In the gap between the damping element 5 and the circumference surface of the pressure boosting element and in the annular region 34, a pressure seepage occurs, i.e. the same pressure prevails in the working chamber 2 and in the damping chamber 22. The gap leakage occurring, however, is slight in comparison to the volumetric flow of fuel that occurs via the cross-section of the damper throttle 24.

In addition, in the region of the damping element 15, a control edge 25 and a number of ground surfaces 26 distributed over the circumference of the piston-shaped pressure boosting element 5 are provided on the circumference of the piston-shaped pressure boosting element 5. In accordance with the stroke distance (reference numeral 29) of the piston-shaped pressure boosting element 5, when the pressure in the differential pressure chamber 6 is relieved, the control edge 25 travels vertically downward so that the ground surfaces 26, which can be disposed along the circumference of the piston shaped pressure boosting element 5, oriented at an angle of 90° in relation to one another, for example, permit highly pressurized fuel to flow out of the working chamber 2 into the damping chamber 22, i.e. the continuing stroke of the pressure boosting element 5 renders the throttle restriction 24 in the damping element 15 ineffective.

The damping element 15 includes a tightly toleranced bore 28, which causes the piston-shaped pressure boosting element 5 to move in its inward travel direction 29 when the pressure in the differential pressure chamber 6 is relieved; in addition, the tightly toleranced bore 28 centers the damping element 15 in relation to the pressure boosting element 5. The piston shaped pressure boosting element 5 is guided inside a guide section 30 in the second housing part 10.2 of the multipart housing 10. The reference numeral 31 identifies an annular surface that is disposed on the piston-shaped pressure boosting element 5 and delimits the differential pressure chamber 6.

The pressure booster shown in the drawing functions in the following manner. The working chamber 2 is filled with fuel via the high-pressure connection 3. The fuel pressure that can be built up by the high-pressure source or that prevails in the chamber inside the high-pressure accumulator also prevails in the working chamber 2 of the pressure booster 1. In the position shown in the drawing, the piston-shaped pressure boosting element 5 of the pressure booster 1 is in its idle position. In this state, the inner ring 20 of the damping element 15, which is embodied as an annular insert piece, covers over the control edge 25 on the piston-shaped pressure boosting element 5, thus covering the open surfaces 26 that extend into the working chamber 2 and can be embodied in the form of ground surfaces. In addition, the inner ring 20 of the damping element 15 also covers over an annular surface 34 that adjoins the for example truncated cone-shaped surface 21 of the piston-shaped pressure boosting element 5. The fuel flowing into the damping chamber 22 from the working chamber 2 of the pressure booster 1 via the damper throttle 24 of the damping element 15 fills the damping chamber 22 and also serves here to supply the fuel pressure that can be built up by the high-pressure source or that prevails in the chamber inside the high-pressure fuel accumulator. The pressure booster 1 is pressure-balanced and is held in its starting position by the return spring element 13.

When the pressure in the differential pressure chamber 6 is relieved by being connected to a low-pressure region of a fuel injection system, which state and region are not shown in the drawing, the pressure in the differential pressure chamber 6 decreases. Because of the high pressure that continues to prevail in the working chamber 2, which is exerted by a high-pressure supply unit, not shown, or a high-pressure accumulator (common rail), the pressure boosting element 5 begins to move downward, thus compressing the fuel in the high-pressure chamber 33 and in the chambers, e.g. a nozzle chamber, that are connected to it a via the connection 9. Because of the volume increase in the damping chamber 22, a gradual pressure decrease occurs because the fuel traveling into the hydraulic chamber 22 from the working chamber 2 of the pressure booster 1 is throttled in accordance with the dimensions of the damper throttle 24.

Because of the damper throttle 24 in the damping element 15, it is not possible for there to be a full compensation for the volume increase of the hydraulic chamber 22 that occurs with the movement of the piston-shaped pressure boosting element 5 in the inward travel direction 29, i.e. toward a high-pressure chamber 33 of the pressure booster 1. The pressure booster 1 generates less pressure inside the high-pressure chamber 33. Inside the hydraulic chamber 22, the surface 21, which is embodied as flat or in the form of a truncated cone, becomes effective as the hydraulic surface 32, as does the annular surface 34 adjoining it, starting from the beginning of the movement of the pressure booster element 5 of the pressure booster 1 because the inner ring 20 of the damping element 15 embodied in the form of an annular insert uncovers the surface 34. Due to the limited pressure buildup inside the hydraulic chamber 22 that is disposed below the damping element 15 and functions as a damping chamber, the piston-shaped pressure boosting element 5, which is subjected to a pressure that is lower than the pressure prevailing in the working chamber 2, moves more slowly into the high-pressure chamber 33. Highly pressurized fuel flows from the high-pressure chamber 33 of the pressure booster 1 into the discharge line 9, to a fuel injector that is not shown in the drawing. Downstream of the high-pressure chamber 33, this fuel injector includes bores adjoining the discharge line 9, a nozzle seat at the combustion chamber end, and injection orifices that function as hydraulic throttle cross sections. Therefore, when a pressure prevails in the high-pressure chamber 33 that is lower than the design pressure of the pressure booster 1, a smaller quantity of fuel flows out. The reduced pressure buildup inside the hydraulic chamber 22 also moves the piston-shaped pressure boosting element 5 more slowly into the high-pressure chamber 33.

When a stroke distance defined by the position of the control edge 25 on the circumference of the piston-shaped pressure boosting element 5 is exceeded, the control edge 25 travels out from the bore 28 of the damping element 15. The open surfaces 26 adjoining the control edge 25 and embodied on the circumference of the piston-shaped pressure boosting element 5 permit fuel to flow from the working chamber 2 of the pressure booster into the hydraulic chamber 22, whose volume continuously increases due to the movement of the piston-shaped pressure boosting element 5 in the direction of the arrow 29. As soon as the control edge 25 travels out from the bore 28 of the annularly embodied damping element 15, the damper throttle 24 is rendered ineffective by the uncovering of the open surfaces 26, and the fuel flows unhindered through the bore 28 and into the hydraulic chamber 22. As a result, in accordance with the inward movement 29 of the piston-shaped pressure boosting element 5 into the pressure-relieved differential pressure chamber 6, the working pressure prevails in the in the hydraulic chamber 22 and therefore acts on the entire end surface, including the surface 34 that was previously covered over by the inner ring 20 of the damping element 15. As a result, the pressure in the high-pressure chamber 33 increases up to the design pressure. The full pressure buildup inside the high-pressure chamber 33, however, only occurs after the fuel quantity required for preinjections has already flowed out into the discharge line 9 and to the fuel injector that is not shown in the drawing. After the control edge 25 has traveled out from the tightly toleranced bore 28 of the annular damping element 15, the design pressure of the pressure booster acts on the piston-shaped pressure boosting element 5, which design pressure is predetermined by the dimensioning of the hydraulically effective surfaces 21 and 34 and by the dimensioning of the surface of the pressure boosting element 5 that is encompassed by the bore 28. The surface of the pressure boosting element 5 that is encompassed by the bore 28 is continuously subjected to the pressure prevailing in the working chamber 2. After the control edge 25 travels out from the bore 28, the pressure in the working chamber 2, which now also prevails in the hydraulic chamber 22, acts on the entire piston cross section (compare to diameter 30) of the pressure boosting element 5.

The design proposed according to the present invention can produce small injection quantities at a low pressure; by contrast, this design of the pressure booster 1 proposed according to the present invention has hardly any negative impact at all on a full pressure buildup for executing main injections by means of the fuel injector into the combustion chamber of an autoignition internal combustion engine. The design of the damper throttle 24 on the damping element 15 and the dimensioning of the diameter of the bore 28 can be used to control both the inward travel speed of the lower end 8 of the piston-shaped pressure boosting element 5 into the high-pressure chamber 33 and the pressure level produced with the gradual inward travel into the high-pressure chamber 33 in the direction 29. The recess 27 provided in the support surface 14 above the damper throttle 24 prevents the return spring 13 from closing the damper throttle 24.

Providing a damper throttle 24 on an annular insert element 15 that functions as a damping element and is already accommodated in a multipart housing 10 of a pressure booster 1 can obviate the need for installing additional components in the pressure booster 1. The annular insert element 15 includes an outer ring 19, which laterally encompasses the return spring 13 resting against the surface 14 of the annular insert 15 so that this return spring 13 is always held in its position against the annular insert 15. The other end of the return spring 13 rests against a disk surface 12 provided on the piston-shaped pressure boosting element 5. The recess 18 on the damping element constitutes the upper stroke stop of the pressure boosting element 5. A stroke stop for the pressure boosting element 5 of the pressure booster 1 can also be constituted by the contact that upper end of the pressure boosting element 5 makes with the first housing part 10.1.

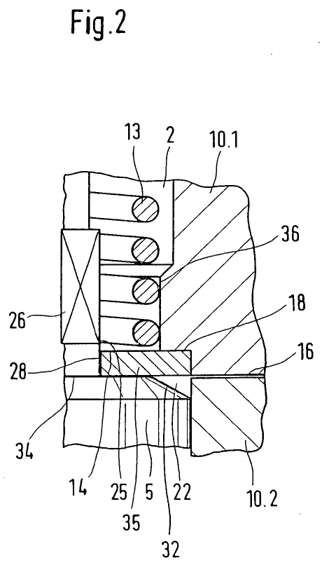

FIG. 2 shows an embodiment variant of a damping element that functions in a stroke-dependent manner.

In the embodiment variant of the annular insert 15 that functions as a damping element according to FIG. 2, this insert element includes an outer ring 19. In the embodiment variant of an annular insert 35 (damping element) shown in FIG. 2, the outer ring has been omitted. The annular insert 35 shown in FIG. 2 is essentially embodied in the form of a disk and is disposed inside a recess 18 in the upper first housing part 10.1 of the pressure booster 1. The return spring 13 acting on the pressure boosting element 5 rests against the support surface 14 of the annular damping element 35. In addition, a contact surface 36 centers the return spring 13 in the first housing part 10.1.

The embodiment of the pressure boosting element 5 in FIG. 2 corresponds essentially to that of the pressure boosting element 5 in FIG. 1, i.e. on the side of the pressure boosting element 5 oriented toward the annular insert 35 in FIG. 2, there is hydraulically effective surface 32, which, analogous to the depiction of the pressure boosting element 5 in FIG. 1, is embodied in the form of a truncated cone 21. The first housing part 10.1 and the second housing part 10.2 rest against each other along a housing division 16. The annular insert 35 contains a bore 28, which encompasses the circumference surface of the pressure boosting element 5 under the control edge 25. Above the control edge 25, open surfaces 26 are provided on the pressure boosting element 5. In addition, the inner ring 20 has been omitted from the annular insert 35 so that the underside of the disk-shaped insert (damping element 35) and the upper end of the pressure boosting element 5 delimit the damping chamber 22.

### REFERENCE NUMERAL LIST

1 pressure booster
2 working chamber
3 high-pressure line
4 inflow direction
5 pressure boosting element
6 differential pressure chamber
7 control line
8 end of pressure boosting element
9 discharge line to fuel injector
10 housing
10.1 first housing part
10.2 second housing part
11 working chamber wall
12 support disk
13 return spring
14 support surface
15 annular insert (damping element)
16 housing division
17 support surface of damping element
18 recess for damping element
19 outer ring
20 inner ring
21 truncated cone-shaped surface
22 hydraulic chamber (damping chamber)
23 delimiting surface
24 damper throttle
25 control edge
26 open surface
27 recess
28 bore
29 inward travel direction
30 guide section of housing 10.2
31 annular surface
32 hydraulically effective surface
33 high-pressure chamber
34 adjoining annular surface - pressure boosting element
35 disk-shaped insert (damping element)
36 support surface of first housing part 10.1

1-12. (canceled)

13. A pressure booster for a fuel injection device, comprising
a piston-shaped pressure boosting element (5) that is accommodated in a housing (10) and divides a working chamber (2) and a differential pressure chamber (6) from each other,
a control line (7) connecting the differential pressure chamber (6) to a high-pressure source or to pressure-relieve it into a low-pressure region,
an annular insert (15) in the housing (10),
a return spring (13) acting on the piston-shaped pressure boosting element (5), the return spring (13) resting against the annular insert (15), and
a damping throttle (24) in the insert (15, 35) via which fuel flows from the working chamber (2) of the pressure booster (1) into a hydraulic chamber (22) when the pressure in the differential pressure chamber (6) is relieved.

14. The pressure booster according to claim 13, wherein a delimiting surface (23) of the insert (15, 35) and a hydraulically effective surface (32, 34) on the piston-shaped pressure boosting element (5) delimit the hydraulic chamber (22).

15. The pressure booster according to claim 13, further comprising means cancelling the action of the damper throttle (24) after the pressure damping element (5) has traveled a particular stroke distance.

16. The pressure booster according to claim 14, wherein in the idle position of the piston-shaped pressure boosting element (5), the insert (15, 35) covers over an annular surface (34) of the piston-shaped pressure boosting element (5) adjoining the hydraulically effective surface (32).

17. The pressure booster according to claim 13, wherein the insert (15) functioning as a damping element comprises an outer ring (19), and an inner ring (20) that delimits a through opening (28).

18. The pressure booster according to claim 17, wherein the outer ring (19) rests on a support surface (17) of a housing part (10.2) of the housing (10).

19. The pressure booster according to claim 17, wherein the outer ring (19) is accommodated in a recess of a wall (11) of the working chamber (2) of the pressure booster.

20. The pressure booster according to claims 13, further comprising the means cancelling the action of the damper throttle (24) after the pressure damping element (5) has traveled a particular stroke distance, and wherein the piston-shaped pressure boosting element (5) comprises a control edge (25), which the insert (15, 35) covers in the idle position of the piston-shaped pressure boosting element (5).

21. The pressure booster according to claim 20, wherein the piston-shaped pressure boosting element (5) comprises open surfaces (26) adjoining the control edge (25), and wherein the circumferential surface of the pressure boosting element (5) in the region of the open surfaces (26) serves to guide and/or center the return spring (13).

22. The pressure booster according to claim 21, wherein the open surfaces (26) are embodied as ground surfaces on the piston-shaped pressure boosting element (5).

23. The pressure booster according to claim 21, wherein the open surfaces (26) extend into the working chamber (2).

24. The pressure booster according to claim 13, wherein the insert (35) functioning as a damping element is embodied as disk-shaped and is accommodated in a recess (18) of a first housing part (10.1) of the housing (10).
